(19) United States
(12) Patent Application Publication
(10) Pub. No.: US 2014/0237474 A1
(43) Pub. Date: Aug. 21, 2014

(54) SYSTEMS AND METHODS FOR ORGANIZING DEPENDENT AND SEQUENTIAL SOFTWARE THREADS

(71) Applicant: APPSENSE LIMITED, Warrington (GB)

(72) Inventor: Paul Keith BRANTON, Rochdale (GB)

(73) Assignee: APPSENSE LIMITED, Warrington (GB)

(21) Appl. No.: 13/770,806

(22) Filed: Feb. 19, 2013

(51) Int. Cl. G06F 9/46

(52) U.S. Cl. CPC G06F 9/46
USPC 718/102

(57) ABSTRACT

Systems and methods are provided for the organization of dependent and sequential software threads running multiple threads of execution on a computing device in order to improve performance and reduce the complexity of thread management. Computing tasks, or jobs, are organized into job wrappers for ordered execution. In response to receiving a request to create a job wrapper, the computing device initializes the job wrapper; initializes a shared data table having a plurality of variables that can be accessed by software threads that comprise the job wrapper; setting a first variable in the plurality of variables to assign a dependency of one software thread to another software thread; finally executing the job wrapper.

### BACKGROUND

1. Technical Field

Disclosed systems and methods relate to the organization of dependent and sequential software threads running multiple threads of execution on a computing device to improve performance and reduce the complexity of thread management.

2. Description of the Related Art

In computer science, a software thread of execution is a sequence of programmed instructions that can be managed and executed independently. Within a given process, there may be multiple threads of execution operating, either dependently or independently, towards completion of a single computing job. Within a process, the comprising threads may share data structures and variables among themselves.

There are several advantages to using a thread-based paradigm for process execution. Multi-threading, the use of multiple threads to execute a process, is advantageous on computer systems with multiple processors or cores. This is mainly because architectures with divided processing power lend themselves well to concurrent thread execution. This advantage has grown more pronounced as computing manufacturers have increasingly evolved their processor designs to involve multiple cores and processing units to keep up with the steady upward demand for greater processing power. While multiple core processors were formerly in the domain of servers, increasing computing demands by consumers caused multi-core processing to trickle down to personal computers as well. As multiple core processors became commonplace in personal computers, demand for software optimized for multi-core processing has similarly increased.

Multi-threaded processing also resolves a problematic situation known as “blocking” “Blocking” operations commonly occur when managing user-interface tasks and input/output data processing. For example, when managing a user interface, a single-threaded process may “block” operations while awaiting user input, which are sporadic and infrequent in comparison to regular computing clock cycles. This “blocking” causes background processes to stall, and makes the application appear to freeze or grind to a halt. In contrast, where the process is multi-threaded, the processing of user input may be given to a single “worker” thread or multiple “worker” threads that run concurrently to the main processing thread, allowing the application to remain responsive to user input while simultaneously continuing to execute tasks in the background.

In the context of input/output processing, “blocking” situations arise where there is a long-running data transfer that requires supplemental processing upon completion of that transfer. For example, consider a job, i.e., a set of required tasks, to perform where files are copied from one Internet cloud service to another, e.g. from a DropBox™ folder to a SkyDrive™ or Box™ folder. The job would include the following discrete tasks:

1. Download a digital file from an Internet cloud service (e.g., DropBox™ storage) over a network to a background buffer on the user's computer.
2. Ask the user to identify the destination for the digital file. (e.g. location in SkyDrive™ or Box™ storage)
3. Upload the file to the location chosen by the user. (e.g. location in SkyDrive™, Box™ storage)

In a single-threaded process, tasks are completed one at a time and in sequence. For example, Task 1 would start processing, then Task 2 would start processing only after Task 1 has completed processing, and then Task 3 would start processing only after Task 2 has completed processing. Some tasks are logically independent from one another while other tasks are dependent on one another. For example, Tasks 1 and 2 are logically independent. However, Task 3 is dependent on Tasks 1 and 2 in that Task 3 cannot start processing until Tasks 1 and 2 have both completed processing.

In a multi-threaded process, tasks can be completed in parallel and out of sequence. For example, Tasks 1 and 2 may run in parallel as Task 2 is not logically dependent on Task 1. In other words, while the computer is downloading the digital file from an Internet cloud service, it may simultaneously ask the user to identify a preferred destination for the digital file. If the download is a long running process, Task 2 may complete prior to Task 1. The early completion of Task 2 allows the computer to initialize the specific software code necessary to upload the digital file to the desired endpoint. This is important as the software code for uploading to SkyDrive™ is different from the software code for uploading to Box™. Until the user has made a choice and completed Task 2, the thread for Task 3, which is dependent on Tasks 1 and 2, cannot determine which code to initialize. Thus, the multi-threading approach allows the computing device to get an early start on initializing Task 3 for execution, and therefore minimizes the “blocking” situation. In the area of input/output processing, this type of execution is referred to as “asynchronous I/O.”

Thus, multi-threading allows different processes to be responsive to user-inputs by moving tasks with long latency, i.e. long-running, to a single “worker” thread or multiple “worker” threads that run concurrently to the main processing thread so that the application may remain responsive to user input while continuing to execute tasks in the background. Similarly, multi-threading allows for more efficient processing of data input/output by processing dependent tasks in an asynchronous manner.

Despite the benefits and widespread use of multi-threaded software, today's operating systems provide no data structures for organizing variables, stored values, flags, or signals among threads within a single process. Instead, they leave it up to software engineers to create their own ad hoc system of variables, stored values, flags, and signals to coordinate execution. While this system may work in a limited threading environment, as software programs increasingly make use of multi-threading they will require more advanced management structures and frameworks.

Accordingly, the systems and methods in the present disclosure address those problems by providing a framework to manage thread interdependencies and sequential parameters. The systems and methods in the present disclosure address the limitations in the prior art through two computing concepts. First, the present disclosure makes use of a “job wrapper” to organize and manage independent threads to achieve individual tasks that collectively comprise the “job.” Secondly, the job wrapper comprises a table that is accessible to all the threads in the job wrapper. This “shared data table” may store variables, which may be used as stored values, flags, signals, and pointers, for use by separate threads when performing different tasks in the job wrapper. The inclusion of the shared data table within the job wrapper data structure creates a formal data structure to manage inter-thread data signals and variables. Moreover, the job wrapper data structure as a whole neatly organizes the aggregate tasks into a single executable job queue.

### SUMMARY

In accordance with the disclosed subject matter, systems and methods are provided for organizing dependent and sequential software threads running multiple threads of execution on a computing device to improve performance and reduce the complexity of thread management.

The disclosed subject matter includes a method. The method can include receiving a request to create a job wrapper comprising a plurality of software threads, wherein the plurality of software threads comprises a first software thread and a second software thread dependent on the first software thread; initializing the job wrapper comprising creating at least one job based on at least the first software thread and the second software thread; initializing a shared data table having a plurality of variables that can be accessed by at least one of the first software thread and the second software thread; and setting a first variable in the plurality of variables to assign a dependency of the second software thread on the first software thread; and in response to initializing the job wrapper, executing the job wrapper.

The disclosed subject matter also includes an apparatus comprising a processor configured to run a module stored in memory. The module can be configured to receive a request to create a job wrapper comprising a plurality of software threads, wherein the plurality of software threads comprises a first software thread and a second software thread dependent on the first software thread; initialize the job wrapper comprising creating at least one job based on at least the first software thread and the second software thread; initializing a shared data table having a plurality of variables that can be accessed by at least one of the first software thread and the second software thread; and setting a first variable in the plurality of variables to assign a dependency of the second software thread on the first software thread; and in response to initializing the job wrapper, executing the job wrapper.

The disclosed subject matter further includes a non-transitory computer readable medium having executable instructions. The executable instructions are operable to receive a request to create a job wrapper comprising a plurality of software threads, wherein the plurality of software threads comprises a first software thread and a second software thread dependent on the first software thread; initialize the job wrapper comprising creating at least one job based on at least the first software thread and the second software thread; initializing a shared data table having a plurality of variables that can be accessed by at least one of the first software thread and the second software thread; and setting a first variable in the plurality of variables to assign a dependency of the second software thread on the first software thread; and in response to initializing the job wrapper, executing the job wrapper.

In one aspect of the method, the apparatus, or the non-transitory computer readable medium, the execution of the job wrapper comprises initiating execution of the first software thread before initiating execution of the second software thread.

In one aspect of the method, the apparatus, or the non-transitory computer readable medium, the execution of the job wrapper comprises initiating execution of the first software thread; accessing and modifying the first variable in the shared data table based on the execution of the first software thread; and in response to modifying the first variable in the shared data table, initiating execution of the second software thread.

In one aspect of the method, the apparatus, or the non-transitory computer readable medium, initiating execution of the second software thread after completion of the execution of the first software thread.

In one aspect of the method, the apparatus, or the non-transitory computer readable medium, initiating execution of the second software thread before completion of the execution of the first software thread.

In one aspect of the method, the apparatus, or the non-transitory computer readable medium, the first variable is a flag that determines when to initiate execution of the second software thread.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

In this respect, before explaining at least one embodiment of the disclosed subject matter in detail, it is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be had to the accompanying drawings and descriptive matter in which there are illustrated preferred embodiments of the disclosed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates a block diagram of a computing environment in accordance with certain embodiments of the disclosed subject matter.

FIG. 2 illustrates a block diagram of a computing device in accordance with certain embodiments of the disclosed subject matter.

FIG. 3 is a flow diagram illustrating a process for initiating a job wrapper in accordance with certain embodiments of the disclosed subject matter.

FIG. 4 is a flow diagram illustrating a process for executing a job wrapper in accordance with certain embodiments of the disclosed subject matter.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the examples provided below are exemplary, and that it is contemplated that there are other systems and methods that are within the scope of the disclosed subject matter.

The disclosed subject matter is aimed at the organization, management, and processing of sequential and dependent software threads operating on a digital device. In computing devices, software threads may be organized into “jobs” that form wrappers for individual “tasks” that are executed by one or more threads. Jobs can be conceptualized as computational “pipelines” which progress through the completion of tasks. Prior to the start of the job, dependencies for the constituent tasks are set by the job wrapper. Threads for executing tasks will not start until the dependencies are satisfied, which is typically when the setting of a flag, such as an “isReady” flag, is detected. Available application protocol interfaces (APIs) today do not allow the pre-creation of a thread queue that runs threads whose actions are determined from previous threads. In other words, the actual threads are not created, i.e. memory allocated and initialized, until the start of the dependent thread. Accordingly, as a job progresses, delays will arise where threads triggered by an “isReady” flag will have to be instantiated and initialized before execution.

APIs today also provide no support for variables and data structures that may be used between dependent threads. Instead, APIs today expect software developers to design, engineer, and juggle their own variables and data structures for their jobs. While this ad hoc system of variables may be acceptable in a limited threading environment, a more advanced framework would greatly assist the developer in creating efficient and functional software code.

The disclosed subject matter is aimed at correcting these problems in the prior art where thread management is limited, and the lack of thread pre-creation reduces efficiency to multi-threading processing. Accordingly, the systems and methods in the present disclosure address those problems by providing a framework to manage thread interdependencies and sequential parameters.

The systems and methods in the present disclosure address the limitations in the prior art through two computing concepts. First, the present disclosure makes use of a “job wrapper” to organize and manage independent threads that may achieve individual tasks that collectively comprise the “job.” Second, the job wrapper comprises a table data structure that is accessible to all the threads in the job wrapper. This “shared data table” may store variables, which may be used as stored values, flags and signals, data structures, and signals for use by separate threads when performing different tasks in the job wrapper. The inclusion of the shared data table within the job wrapper data structure creates a formal data structure to manage inter-thread, intra-process variables. Moreover, the job wrapper as a whole neatly organizes the aggregate tasks into a single executable job queue.

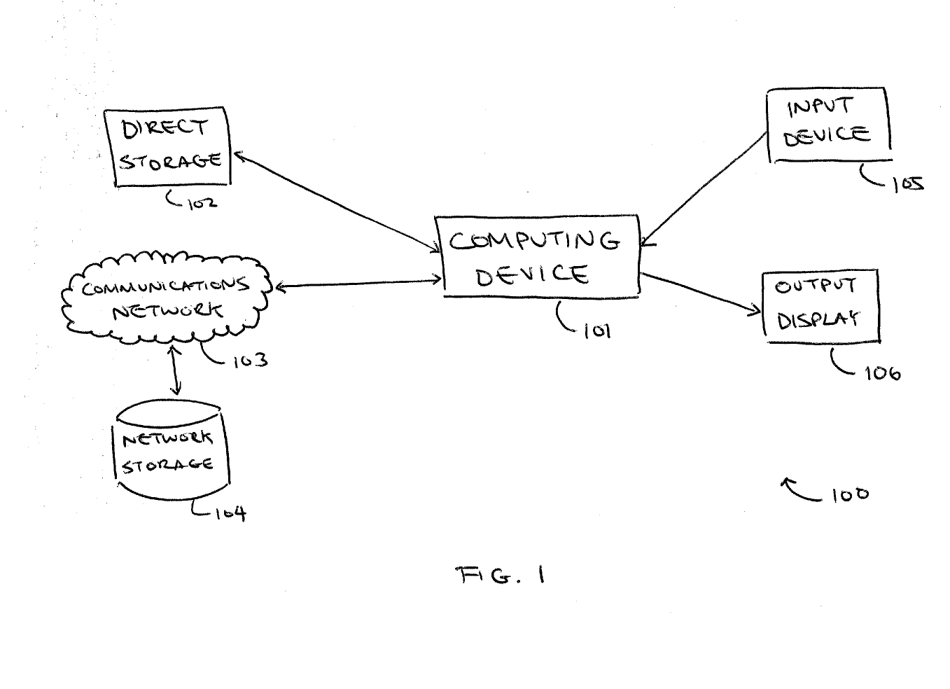

FIG. 1 illustrates a diagram of a networked electronic system in accordance with an embodiment of the disclosed subject matter. The networked system 100 can include a computing device 101, direct storage 102, communications network 103, network storage 104, input device 105, and output display 106.

The computing device 101 can include a desktop computer, a mobile computer, a tablet computer, a cellular device such as a smartphone, or any computing system that is capable of performing computation. The computing device 101 can send data to, and receive data from, direct storage 102 and network storage 104 via communications network 103. Although not shown, computing device 101 can also include its own local storage medium. The local storage medium can be a local magnetic hard disk or solid state flash drive within the device. Alternatively or in addition, the local storage medium can be a portal storage device, such as a USB-enabled or Firewire-enabled flash drive or magnetic disk drive. As shown in FIG. 1, computing device 101 can receive input signals from the input device 105 as well as send display data to output display 106.

In addition to local storage within computing device 101, each computing device 101 can be directly coupled to the external direct storage 102 using direct cable interfaces such as USB, eSATA, Firewire, Thunderbolt interfaces. Alternatively, each client 101 can be connected to cloud storage in communications network 103 via any other suitable device, communication network, or combination thereof. For example, each client 101 can be coupled to the communications network 103 via one or more routers, switches, access points, and/or communication networks (as described below in connection with communications network 103).

The communications network 103 can include the Internet, a cellular network, a telephone network, a computer network, a packet switching network, a line switching network, a local area network (LAN), a wide area network (WAN), a global area network, or any number of private networks that can be referred to as an Intranet.

The communications network 103 can also be coupled to a network storage 104. The network storage 104 can include a local network storage and/or a remote network storage. Local network storage and remote network storage can include at least one physical, non-transitory storage medium. Such networks may be implemented with any number of hardware and software components, transmission media and network protocols. FIG. 1 shows the communications network 103 as a single network; however, the communications network 103 can include multiple interconnected networks listed above.

The input device 105 can be configured as a combination of circuitry and/or software capable of receiving an input signal. In some embodiments, the input device 105 can be configured as a touchscreen and controller chip in combination with specific driver software. In such embodiments, the input device 105 can be configured to sense inputs on a touchscreen from a stylus or one or more fingertips. In other embodiments, the input device 105 can be configured to sense inputs from a mouse, trackball, touchpad, track pad, control stick, keyboard, or other input device.

The output display 106 can be an external monitor, such as a desktop monitor or terminal screen. Alternatively, the output display 106 can be integrated into the computing device 101. When integrated into the computing device 101, the output display 106 can be a liquid crystal display (LCD), light emitting diode (LED) display, or even a display comprising cathode ray tubes (CRT).

Although computing device 101, input device 105, and output display 106 are shown in FIG. 1 as separate components, all of these components, or any combination thereof, can be integrated into a single device. For example, a tablet computer and smartphone can have the computing device 101 (tablet or phone), input device 105 (touchscreen sensors) and output display 106 (touchscreen display) integrated into a single device.

The disclosed embodiment may involve retrieval by the computing device 101 of a wide variety of file types from direct storage 102, cloud communication network 103, and network storage 104 and/or local storage medium on computing device 101. Such file types can include, for example, TXT, RTF, DOC, DOCX, XLS, XLSX, PPT, PPTX, PDF, MPG, MPEG, WMV, ASF, WAV, MP3, MP4, JPEG, TIF, MSG, or any other suitable file type or combination of file types. These files can be stored in any suitable location within direct storage 102, cloud communication network 103, and network storage 104 and/or local storage medium on computing device 101. Additionally, the disclosed embodiment may involve retrieval of content, such as web pages, streaming video from the Internet, or any other suitable content.

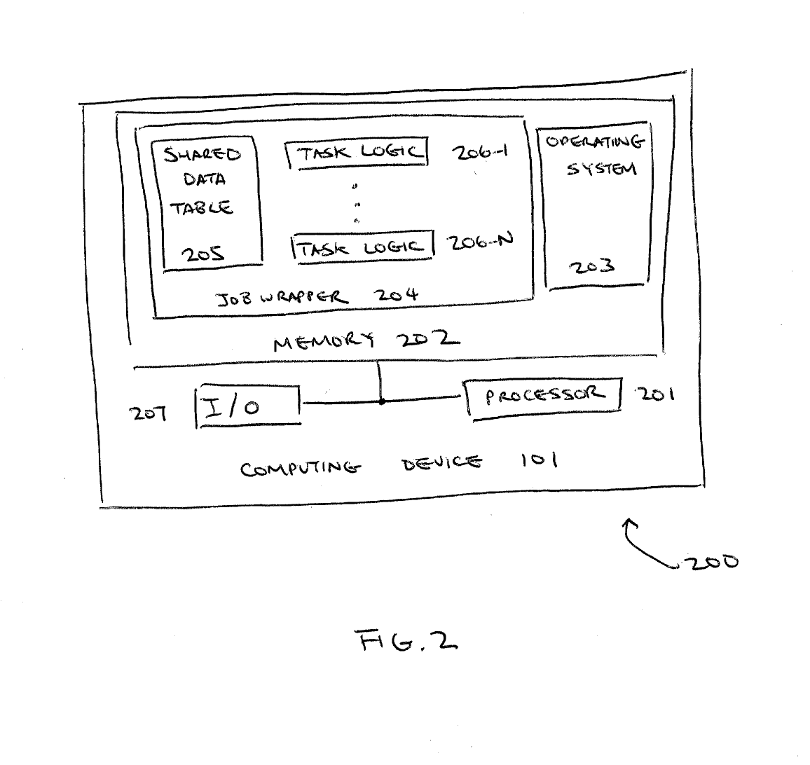

FIG. 2 illustrates a block diagram of a computing system incorporating an embodiment of the disclosed subject matter. The computing system can include a computing device 101 which may include a processor 201, memory 202, and input/output component 207.

The computing device 101 can include a desktop computer, a mobile computer, a tablet computer, a cellular device such as a smartphone, or any computing system that is capable of performing computation.

Within the computing device 101, processor 201 can be configured as a central processing unit or application processing unit in computing device 101. Processor 201 can also be implemented in hardware using an application specific integrated circuit (ASIC), programmable logic array (PLA), field programmable gate array (FPGA), or any other integrated circuit.

Memory 202 can be a random access memory of either cache memory, non-transitory computer readable medium, flash memory, a magnetic disk drive, an optical drive, a programmable read-only memory (PROM), a read-only memory (ROM), or any other memory or combination of memories.

Memory 202 includes an operating system module 203 and a job wrapper module 204. The operating system module 106 can be configured as a specialized combination of software capable of handling standard operations of the device, including allocating memory, coordinating system calls, managing interrupts, local file management, and input/output handling. The job wrapper module 107 comprises several submodules, including a shared data table data structure 108 and task logic 206-1 through 206-N. The shared data table data structure 108 can include data entries for variables, which may represent stored values, signals, flags, and pointers. The task logic 206-1 through 206-N can include threading logic to perform Tasks 1 through N.

Input/Output controller 207 can include a specialized combination of circuitry (such as ports, interfaces, wireless antennas) and software (such as drivers) capable of handling the reception of data and the sending of data to direct storage 102 and/or network storage 104 via communications network 103.

In addition to handling communications between the computing device 101 and storage units 102 and 104, communications network 103, Input/Output controller 202 can also receive input signals from the input device 105 and send display signals to output display 106. Accordingly, in some embodiments, the Input/Output controller 202 can be configured to interface with specialized hardware capable of sensing inputs on a touchscreen from a stylus or one or more fingertips. In other embodiments, Input/Output controller 202 can be configured to interface with input device 105, which may be specialized hardware capable of sensing inputs from an input device, such as, for example, a mouse, trackball, touchpad, track pad, control stick, and keyboard.

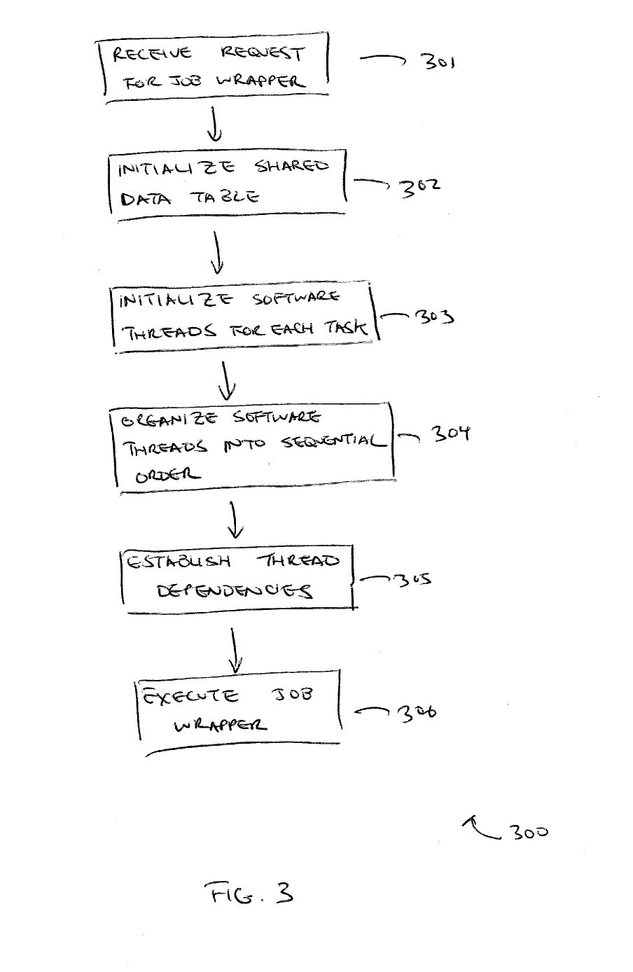

FIG. 3 is a flow diagram illustrating a process 300 for initiating a job wrapper in accordance with certain embodiments of the disclosed subject matter. Process 300 takes place in the computing device 101 as described above in connection with FIG. 1. In Step 301, the computing device 101 can be configured to receive a request for job wrapper 204. This request may be initiated by user input via the input device 102 or through software by a logic module loaded into memory 105, such the operating system module 106.

Upon receiving a request for the job, the computing device 101 initializes the job wrapper, which triggers several events. In Step 302, the computing device 101 instantiates a shared data table 205 to store variables for the threads in the job wrapper 204 that will be performing the tasks that comprise the job. This data structure may be formed using a variety of configurations, such with a conventional array or a dynamic linked list. Instantiation of the shared data table 205 requires coordination between the code in the job wrapper 204, the operating system module 203, and processor 201 for tasks such as the allocation memory within memory 202.

In Step 303, the computing device 101 instantiates software threads 206-1 through 206-N within the job wrapper 204, one thread for each task that works to complete the job. Jobs may also be executed using a plurality of threads as well. Continuing the earlier example, to transfer a file from one Internet cloud service to another, e.g. from a DropBox™ folder to a SkyDrive™ or Box™ folder, the job includes three distinct tasks:

1. Download a digital file from an Internet cloud service (e.g., DropBox™ storage) over a network to a background buffer on the user's computer. (E.g., Task 1 corresponding to task logic 206-1)
2. Ask the user to identify the destination for the digital file. (e.g. location in SkyDrive™ or Box™ storage). (E.g., Task 2 corresponding to task logic 206-2)
3. Upload the file to the location chosen by the user. (e.g. location in SkyDrive™, Box™ storage). (E.g., Task 3 corresponding to task logic 206-3)

In this example, each of these tasks may be executed by at least one thread. In Step 204, the threads are organized into sequential order. The order does not need to be strictly sequential, as some threads may run asynchronously to others due to lack of dependency. In the example above, Task 2 may be executed co-terminously with Task 1 if Task 1 has a long transmission time due to a large file size. Hence, a job queue may be completely created ahead of its execution. This cuts down on execution time since the thread is already loaded and prepared in memory 205.

Along with ordering the threads, in Step 305, the computing device also establishes the threading dependencies. This may be accomplished by initializing signals within different entries in the shared data table 205. The contents of those entries may be important for determining when individual threads 206-1 through 206-N, and hence tasks within the job, may be executed. Once the job wrapper 204 has started executing, the shared data table 205 may manage the signals set by the different threads within the job wrapper. The shared data table 205 advantageously provides a central, standardized data structure to locate and store all of the necessary signals to manage inter-thread dependencies.

During execution of the job wrapper 204, the computing device 101, on behalf of threads 206-1 through 206-N, can be configured to constantly poll the entries of the shared data table 205 to determine the current status of those signal. When a thread polls the shared data table 205, the wrapper will retrieve the entry of the shared data table 205 and process the containing signal to determine its status. Depending on the status of the signal, the appropriate thread, and thus the task, may or may not begin to execute. During the initialization of the job wrapper 204, the computing device may allocate entries for those signals and reset those signals for use by the threads.

In Step 306, the job wrapper may begin execution, beginning with the starting thread 206-1. During execution, threads through 206-N may access or edit the entries in the stored data table 205. Thus, information obtained in early threads can be used to influence the jobs created in subsequent threads. These entries may be variables for computational use or they may be signals to trigger the initiation of subsequent threads.

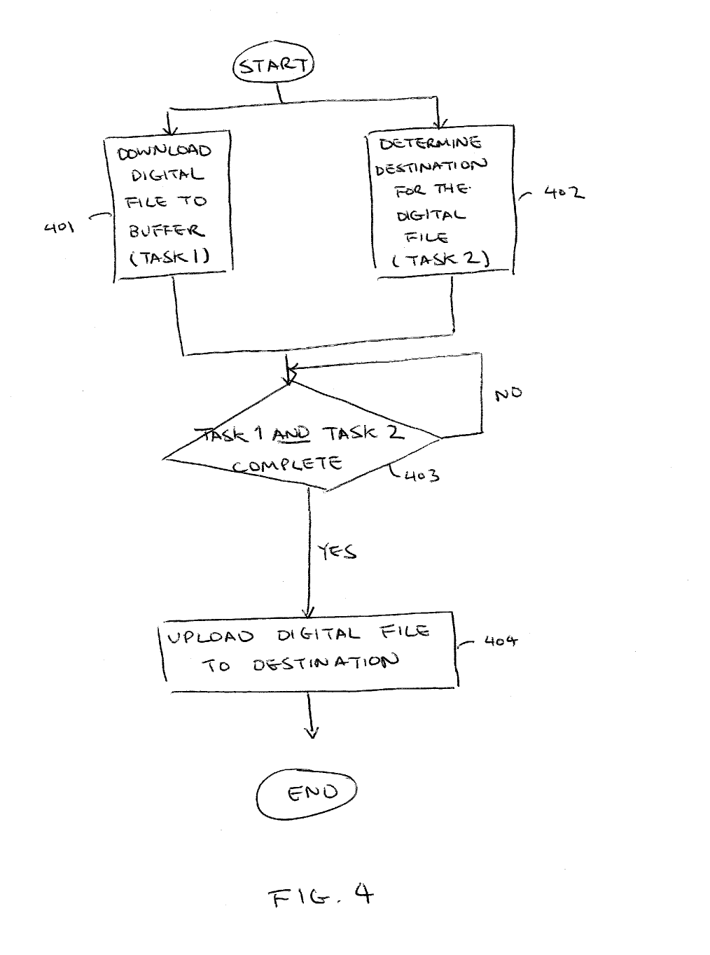

FIG. 4 is a flow diagram illustrating a process 400 for executing a job wrapper in accordance with certain embodiments of the disclosed subject matter. In Step 401, which corresponds to Task 1, the digital file is downloaded from its source over the Internet, e.g. DropBox™ folder. During this step, the instructions in the task logic 206-1 (job wrapper 204) are executed and managed by the processor 201 and Input/Output controller 207 in the computing device 101. The transmitted data traverses the communications network 103 from the network storage unit 104 (i.e. DropBox™ storage) to the computing device 101 and vice-versa.

In Step 402, which corresponds to Task 2, the computing device executes task logic 206-2 in a separate worker thread in order to retrieve user inputs from the input device 105, and interpret and manage the signals using processor 201 and input/output controller 207. By using a separate threads, Steps 401 and 402 may run in parallel to avoid “blocking” Although Steps 401 and 402 are shown as running in parallel, the steps may run sequentially in any suitable order.

In Step 403, the computing device determines whether processing of Step 401 (Task 1) and Step 402 (Task 2) are both complete. This may be accomplished by processor 201 polling or constantly checking the shared data table 205 for the appropriate variables or signals that have been set in Steps 401 and 402. Upon recognition of the proper signal, Step 404 may commence.

In Step 404, which corresponds to Task 3, the computing device executes task logic 206-3 in uploading the digital buffer to a network storage location. Task logic 206-3 can be executed by the processor 201 and Input/Output controller 207. Data is then be sent through the communications network 103 to network storage 104 (i.e., SkyDrive™ or Box™ storage).

Accordingly, Steps 401, 402, and 403, which correspond to respective Tasks 1, 2, and 3, need not be resolved in a step-wise fashion. As Task 1 and Task 2 are independent of each other, they may run in parallel. In contrast, Task 1 and Task 2 need to be completed prior to Task 3 fully executing. For initialization, however, Task 1 and Task 2 need not be complete before initializing. For example, in Task 2, if the user selects a SkyDrive™ destination, Task 2 may set a signal in the shared data table 205 to indicate to the thread running Task 3 that the code should connect to SkyDrive™. Task 3 can then begin initializing a connection to SkyDrive™ ahead of time in preparation for the completion of Task 1. In this way, the shared data table 205 can facilitate the dependencies between Task 2 and Task 3 to increase processing efficiency.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. The embodiment illustrated in FIGS. 1-4 are merely an example of an application of the claimed invention. The claimed invention also applies to any suitable job, task, job wrapper, series of tasks, and associated dependencies, and independencies. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A method comprising:
receiving a request to create a job wrapper comprising a plurality of software threads, wherein the plurality of software threads comprises a first software thread and a second software thread dependent on the first software thread;
initializing the job wrapper comprising:
creating at least one job based on at least the first software thread and the second software thread;
initializing a shared data table having a plurality of variables that can be accessed by at least one of the first software thread and the second software thread; and
setting a first variable in the plurality of variables to assign a dependency of the second software thread on the first software thread; and
in response to initializing the job wrapper, executing the job wrapper.

2. The method of claim 1, wherein executing the job wrapper comprises initiating execution of the first software thread before initiating execution of the second software thread.

3. The method of claim 1, wherein executing the job wrapper comprises:
initiating execution of the first software thread;
accessing and modifying the first variable in the shared data table based on the execution of the first software thread; and
in response to modifying the first variable in the shared data table, initiating execution of the second software thread.

4. The method of claim 3, further comprising initiating execution of the second software thread after completion of the execution of the first software thread.

5. The method of claim 3, further comprising initiating execution of the second software thread before completion of the execution of the first software thread.

6. The method of claim 1, wherein the first variable is a flag that determines when to initiate execution of the second software thread.

7. The method of claim 1, further comprising:
creating the at least one job that is further based on a third software thread that is dependent on the first software thread and independent of the second software thread;
initializing the shared data table having the plurality of variables that can be further accessed by the third software thread;
setting a second variable in the plurality of variables to assign a dependency of the third software thread on the first software thread; and
initiating execution of the second software thread and the third software thread after initiating execution of the first software thread.

8. A non-transitory computer readable medium having executable instructions that are operable to cause a data processing apparatus to:
receive a request to create a job wrapper comprising a plurality of software threads, wherein the plurality of software threads comprises a first software thread and a second software thread dependent on the first software thread;
initialize the job wrapper comprising:
creating at least one job based on at least the first software thread and the second software thread;
initializing a shared data table having a plurality of variables that can be accessed by at least one of the first software thread and the second software thread; and
setting a first variable in the plurality of variables to assign a dependency of the second software thread on the first software thread; and
in response to initializing the job wrapper, executing the job wrapper.

9. The computer readable medium of claim 8, further comprising executable instructions operable to cause the data processing apparatus to initiate execution of the first software thread before initiating execution of the second software thread.

10. The computer readable medium of claim 8, further comprising executable instructions wherein execution of the job wrapper comprises:
initiating execution of the first software thread;
accessing and modifying the first variable in the shared data table based on the execution of the first software thread; and
in response to modifying the first variable in the shared data table, initiating execution of the second software thread.

11. The computer readable medium of claim 10, further comprising executable instructions operable to cause the data processing apparatus to initiate execution of the second software thread after completion of the execution of the first software thread.

12. The computer readable medium of claim 10, further comprising executable instructions operable to cause the data processing apparatus to initiating execution of the second software thread before completion of the execution of the first software thread.

13. The computer readable medium of claim 8, wherein the first variable is a flag that determines when to initiate execution of the second software thread.

14. An apparatus comprising:
a processor configured to run a module stored in memory, the module configured to:
receive a request to create a job wrapper comprising a plurality of software threads, wherein the plurality of software threads comprises a first software thread and a second software thread dependent on the first software thread;
initialize the job wrapper comprising:
creating at least one job based on at least the first software thread and the second software thread;
initializing a shared data table having a plurality of variables that can be accessed by at least one of the first software thread and the second software thread; and
setting a first variable in the plurality of variables to assign a dependency of the second software thread on the first software thread; and
in response to initializing the job wrapper, executing the job wrapper.

15. The apparatus of claim 14, wherein the module configured to execute the job wrapper is configured to initiate execution of the first software thread before initiating execution of the second software thread.

16. The apparatus of claim 14, wherein the module configured to execute the job wrapper is configured to:
initiate execution of the first software thread;
access and modify the first variable in the shared data table based on the execution of the first software thread; and
in response to modifying the first variable in the shared data table, initiate execution of the second software thread.

17. The apparatus of claim 16, wherein the execution of the job wrapper further comprises initiating execution of the second software thread after completion of the execution of the first software thread.

18. The apparatus of claim 16, wherein the execution of the job wrapper further comprises initiating execution of the second software thread before completion of the execution of the first software thread.

19. The apparatus of claim 14, wherein the first variable is a flag that determines when to initiate execution of the second software thread.

20. The apparatus of claim 14, wherein the module is further configured to:
create the at least one job that is further based on a third software thread that is dependent on the first software thread and independent of the second software thread;
initialize the shared data table having the plurality of variables that can be further accessed by the third software thread;
set a second variable in the plurality of variables to assign a dependency of the third software thread on the first software thread; and
initiate execution of the second software thread and the third software thread after initiating execution of the first software thread.
